(19) United States
(12) Patent Application Publication
(10) Pub. No.: US 2009/0279543 A1
(43) Pub. Date: Nov. 12, 2009

(54) Method and System for Handling Tethered User Devices in a Telecommunications Network

(75) Inventors: Thomas D. Strom, Naperville, IL (US); Suresh Kumar, Naperville, IL (US); Michael W. Delafchell, Warrenville, IL (US)

Correspondence Address: FAY SHARPE/LUCENT, 1228 Euclid Avenue, 5th Floor, The Halle Building, Cleveland, OH, 44115-1843, US

(73) Assignee: Lucent Technologies Inc.

(21) Appl. No.: 12/116,015

(22) Filed: May 6, 2008

(51) Int. Cl. H04L 12/56

(52) U.S. Cl. 370/389

(57) ABSTRACT

The presently described embodiments relate to a method for handling data sessions performed using tethered user devices in a network. The presently described embodiments are directed to network functionality to receive a tethered device indicator by a network element. The tethered device indicator, in at least one form, originates from a request from a user device. The indicator is then detected by the network and, based on the indicator, a variety of functions may be performed. For example, a network element may determine that a data session is not proper and, therefore, reject the data session that is requested by the user device. Alternatively, the network element may determine that the data session request is proper. In this case, the data session will be managed based on the indicator.

### BACKGROUND OF THE INVENTION

This invention relates to a method and system for handling tethered user devices in a telecommunications network.

While the invention is particularly directed to the art of detecting tethered devices and addressing the use of such tethered devices, and will be thus described with specific reference thereto, it will be appreciated that the invention may have usefulness in other fields and applications.

By way of background, service providers allow users using devices such as mobile phones, smart phones, and the like, e.g. User Equipment (UE), to access their networks for the purpose of invoking packet data services. The current state of the art relative to UEs is that, in general, UEs themselves do not send or receive large amounts of packet data. However, users are able to connect (or “tether”) other data devices such as laptop computers to the UE, and as a result, send/receive much larger amounts of packet data which the service providers consider unacceptable. The UE knows whether or not it is connected to a tethered device, but there is no method currently implemented for the UE to convey this information to the network. Indeed, no such method or technique is defined in 3GPP standards.

Thus, there is a need to provide functionality such that the network is able to detect when a tethered data device is being used. If so, the corresponding data session could be accepted or rejected by the network. If accepted by the network, the tethered data session could then be managed.

There is no known solution currently. There is no technique for the network to detect that a UE is connected (tethered) to another device such as a laptop. Consequently, there is no known technique for managing the data sessions based on the knowledge that the UE is connected to a tethered device.

### SUMMARY OF THE INVENTION

In one aspect of the invention, a method comprises receiving a tethered device indicator by a network element, the tethered device indicator originating from a request message from a user device, detecting the indicator by the network element, and, based on the indicator, performing one of rejecting a data session requested by the user device or managing the data session requested by the user device.

In another aspect of the invention, the tethered device indicator is a flag set in an information element of the request message.

In another aspect of the invention, the request message is data session request message.

In another aspect of the invention, the data session request message is a PDP Context Request message.

In another aspect of the invention, the request message is a request to modify a data session.

In another aspect of the invention, the request to modify a data session is a Modify PDP Context Request message.

In another aspect of the invention, the request message is a routing area update request.

In another aspect of the invention, the method further comprises sending the indicator by the network element to a second network element based on a relocation request.

In another aspect of the invention, the method further comprises sending a reject message to the user device if rejecting is performed by the network element.

In another aspect of the invention, managing the data session includes at least one of setting a quality of service and establishing a rate plan.

In another aspect of the invention, a system comprises means for receiving a tethered device indicator by a network element, the tethered device indicator originating from a request message from a user device, means for detecting the indicator by the network element, and, based on the indicator, means for performing one of rejecting a data session requested by the user device or managing the data session requested by the user device.

In another aspect of the invention, the tethered device indicator is a flag set in an information element of the request message.

In another aspect of the invention, the request message is data session request message.

In another aspect of the invention, the data session request message is a PDP Context Request message.

In another aspect of the invention, the request message is a request to modify a data session.

In another aspect of the invention, the request to modify a data session is a Modify PDP Context Request message.

In another aspect of the invention, the request message is a routing area update request.

In another aspect of the invention, the system further comprises means for sending the indicator by the network element to a second network element based on a relocation request.

In another aspect of the invention, the system further comprises means for sending a reject message to the user device if rejecting is performed by the network element.

In another aspect of the invention, means for managing the data session includes at least one of setting a quality of service and establishing a rate plan.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which.

FIG. 1 is a block diagram of a network into which the presently described embodiments may be incorporated.

FIG. 2 is a call flow diagram illustrating an embodiment of the present application.

FIG. 3 is a call flow diagram illustrating an embodiment of the present application.

FIG. 4 is a call flow diagram illustrating an embodiment of the present application.

FIG. 5 is a call flow diagram illustrating an embodiment of the present application.

FIG. 6 is a call flow diagram illustrating an embodiment of the present application.

### DETAILED DESCRIPTION

The presently described embodiments relate to a method for handling data sessions performed using tethered user devices in a network. For reasons noted above, it is advantageous to be able to detect whether a tethered device is connected to the network and is requesting a data session. Therefore, the presently described embodiments are directed to network functionality to receive a tethered device indicator by a network element. The tethered device indicator (or tethering indication), in at least one form, originates from a request from a user device. The indicator is then detected by the network and, based on the indicator, a variety of functions may be performed. For example, a network element may determine that a data session is not proper and, therefore, reject the data session that is requested by the user device. Alternatively, the network element may determine that the data session request is proper. In this case, the data session will be managed based on the indicator.

It will be appreciated that the network elements may take a variety of forms as will be apparent from the discussion below. For example, the network into which the presently described embodiments are incorporated may be a UMTS network. So, the network elements may take the form of serving GPRS support nodes and other connected network elements that reside in a UMTS network. In a UMTS environment, a user device is referred to as user equipment (UE). In one form, the presently described embodiments can be applied in such a UMTS network as will be described in detail below.

However, it should be appreciated that the principles of the presently described embodiments may be applied to a variety of other types of networks. For example, those of skill in the art will understand that the presently described embodiments may be applied to a CDMA network, an EVDO network, and a WiMax network, to name but a few. Those of skill in the art will further appreciate that translation of the presently described embodiments to these types of networks can be realized because these types of wireless networks typically include a user device, a network element such as a receiving station or base station, and a variety of other network elements such as switching elements that function to achieve many of the same objectives as the network elements of the UMTS network.

It should be further appreciated that the presently described embodiments, in any of the possible technology environments, may be implemented in the network in a variety of different manners. For example, a variety of different hardware configurations and/or software techniques may be used to implement the presently described embodiments. In one form, suitable routines may be distributed throughout the network elements and executed by such network elements to achieve the objectives of the presently described embodiments. In some forms, it may be advantageous to have a more centralized set of routines that allow the network elements to perform the appropriate functions.

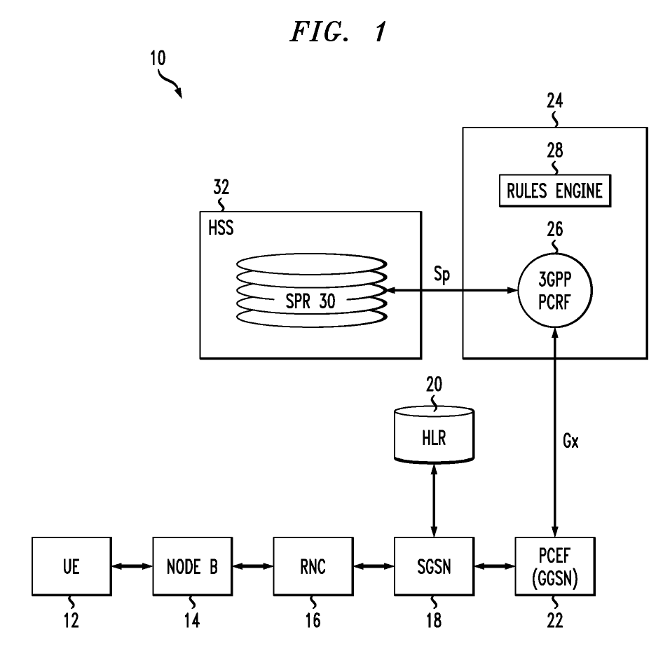

Referring now to the drawings wherein the showings are for purposes of illustrating the exemplary embodiments only and not for purposes of limiting the claimed subject matter, FIG. 1 provides a view of an example system 10 into which the presently described embodiments may be incorporated. As shown generally, FIG. 1 is based on the 3GPP Policy and Charging Contro (PCC) model. However, as those of skill in the art will appreciate, the presently described embodiments may also be applied to other models and architectures including the Resource and Admission Control Subsystem (RACS) architecture (defined by ETSI TISPAN), the Service Based Bearer Control (SBBC) architecture (defined by 3GPP2) and the Resource and Admission Control Function (RACF) architecture (defined by ITU).

The system or network 10 is an example UMTS network accessed by a user device, e.g. User Equipment (UE) 12. The network includes (without limitation) a Node B 14 and a Radio Network Controller (RNC) 16 that enables communication to a Serving GPRS Support Node (SGSN) 18. The SGSN 18 has access to a Home Location Register (HLR) 20 and is operative to communicate with a Gateway GPRS Support Node (GGSN) 22, also including functionality for a Policy and Charging Enforcement Function (PCEF). Also shown in the network 10 is a resource manager 24 having a Policy Charging Rule Function (PCRF) 26 and a rules engine 28. In one form, the network 10 may also include a subscriber profile repository (SPR) 30, which could be housed, in one form, within a home subscriber system (HSS) 32. Other repositories also may be implemented. Such other repositories may be controlled by different service providers—one is shown as merely an example of a configuration.

It should also be appreciated that other network elements (not shown in FIG. 1) may be included within networks that implement the presently described embodiments. For example, when a UE 12 moves or is moved from control of one location area to another location area, a second SGSN or a second Node B or second RNC may be provided. At least some of these types of devices not specifically illustrated are shown in other drawings herein. Those of skill in the field will understood the manner in which such network elements are situated and implemented within the network 10.

According to the presently described embodiments, the user device or UE 12, provides an indication that a device is tethered to the UE 12 in a request message, such as an Activate PDP Context Request message. This message is sent to the SGSN 18. The Activate PDP Context message is typically sent by the UE 12 to the SGSN 18 when a PDP context is set up. In accord with the presently described embodiments, this request message is supplemented with tethered device information, such as a flag set in an information element (IE) as a tethered device indicator. Other manners of providing such a tethered device indicator in the message may also be used. In any event, the UE 12 has the functionality to recognize when it is tethered and the further functionality to, for example, populate the appropriate field in the request message.

Thus, when the requested PDP context is being established, the SGSN 18 can check whether a tethered device is being used by checking the Activate PDP Context Request message contents. Then, the SGSN 18 can check whether a data session should be allowed using this tethered device. There are two methods for making this determination:

a) The SGSN 18 can check operator or service provider provisioned data to determine if the user session should be accepted or rejected.

b) The SGSN can check the contents of the subscriber profile information previously retrieved from the HLR database 20. The HLR database 20 could be extended to add an additional field to indicate which subscribers are allowed to use tethered devices and which subscribers are not allowed to do so.

If the network, e.g. SGSN 18, determines that a tethered data session should be established, the SGSN 18 signals to the GGSN 22 to set it up. When the GGSN 22 receives the request, it signals to the PCRF 26 (via a Gx interface) to get authorization for the request. The PCRF 26, in turn, retrieves subscriber specific data from the SPR database 30 (via an Sp interface) to make a decision regarding what level of QoS to grant to the UE 12. The PCRF 26 also determines how the subscriber should be charged for the session. The PCRF 26 then provides QoS and charging information to the GGSN 22. The use of the PCRF 26 and GGSN 22 in this manner is well defined in 3GPP standards.

The presently described embodiments enhance this functionality to allow the PCRF 26 to know whether the user is making use of a tethered device. The enhancements are as follows:

1) The SGSN 18 passes the tethering indication to the GGSN 22 in the existing GTP protocol.

2) The GGSN 22 passes the tethering indication to the PCRF 26 when the PDP context is being established.

3) The PCRF 26 uses the tethering indication in making decisions about QoS to grant the user session, and/or how to charge the user for the session. For example, if the user is using a tethered device, the operator may want the QoS to be downgraded, the charging rate to be increased, or both.

It should further be understood that the network recognition of a tethered device may also provide options to the end user. So, upon detection of the tethered device and determination that the data session may be conducted, the system may warn the user that a surcharge will apply. If the user agrees, then the surcharge is applied, and if the user does not agree, the session is rejected.

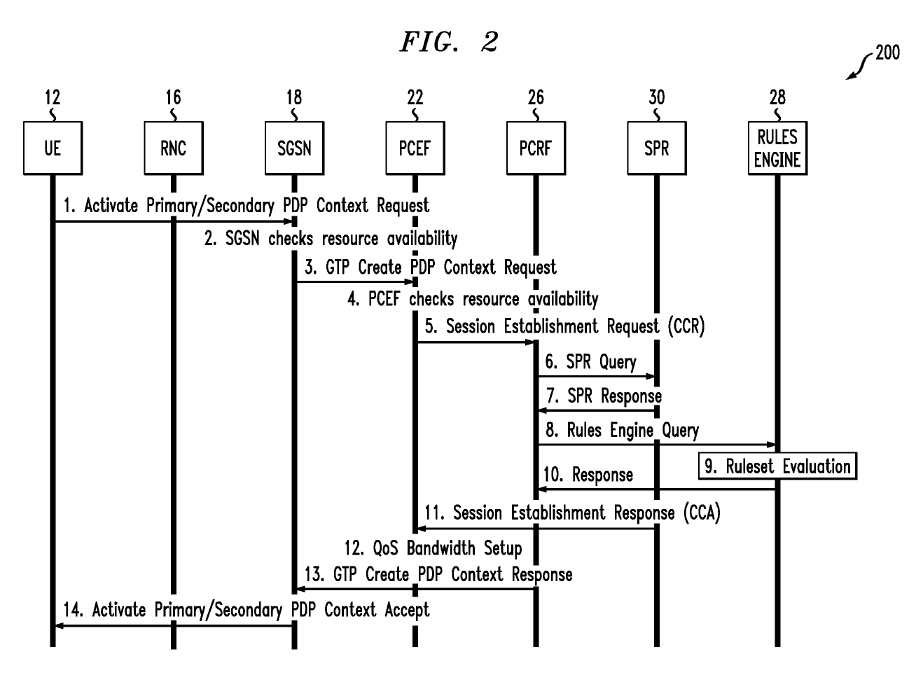

A call flow 200 showing an example of the presently described embodiments where a tethered data session is established is provided in FIG. 2. As shown, at line 1, UE 12 requests the establishment of a bearer (e.g. to establish a data session) by sending a request message such as an Activate PDP Context Request to the serving SGSN 18. The requested bearer could be a Primary PDP context or a Secondary PDP context. The UE 12 provides a new tethering indication (also referred to as a tethered device indicator) to the SGSN 18 in, for example, an information element of the request message.

At line 2, SGSN 18 determines if sufficient resources are available for the bearer. The resources requested by the UE 12 are verified against the subscriber profile information which was previously downloaded from the HLR 20 when the UE 12 attached. The assumption here is that the SGSN 18 does not reject the PDP context activation if the UE 12 has indicated a tethered device is connected.

At line 3, SGSN 18 sends the Create PDP Context Request for the bearer to the PCEF (GGSN) 22 if there are sufficient resources for the new session. The SGSN 18 includes the tethered indication provided by the UE 12.

At line 4, PCEF 22 determines if sufficient resources are available for the bearer. The amount of resources needed for a new session is provisioned based on the worst case scenario of supported services. If there are sufficient resources available, the new data session is allowed.

At line 5, PCEF 22 sends session establishment request for the new session to the PCRF 26 over the Gx interface. Information derived from the PDP context, including the new tethering indication is included.

At line 6, PCRF 26 forwards a query to the SPR 30 to retrieve UE 12 subscriber data. If the SPR data is already locally cached at the PCRF 26 the query/response is skipped (proceed to step 8).

At line 7, the SPR 30 returns the stored subscriber data for the UE 12 to the PCRF 26.

At line 8, PCRF 26 formats and sends a query to the rules engine 28 using data retrieved from the SPR 30, parameters received in the CCR command from the PCEF 22, UE tethering indication, etc.

At line 9, the rules engine 28 invokes the ruleset specified by the PCRF 26 in the query request. The ruleset calculates, for example, some or all of the quality of service (QoS) and charging parameters needed for the session.

At line 10, the rules engine 28 formats and sends a response to the PCRF 26 containing the parameters resulting from the ruleset invocation. Example parameters returned for this use case are ones to derive the QoS Information AVP in the CCA message to be sent to the PCEF (GGSN) 22. The tethering indication could be used here, or in the previous step to calculate QoS and/or charging to use for the session.

At line 11, PCRF 26 formats a CCA command response and sends it to the PCEF 22. The CCA command AVPs are derived from parameters returned in the response from the rules engine 28 as well as local data at the PCRF 26.

At line 12, PCEF 22 allocates resources to the data session using throughput rate and QoS parameters set by PCRF 26 and enforces the service policy.

At line 13, PCEF 22 sends the parameters for the PDP context in the response to the create PDP context request.

At line 14, SGSN 18 notifies UE 12 that the setup of the PDP context is complete.

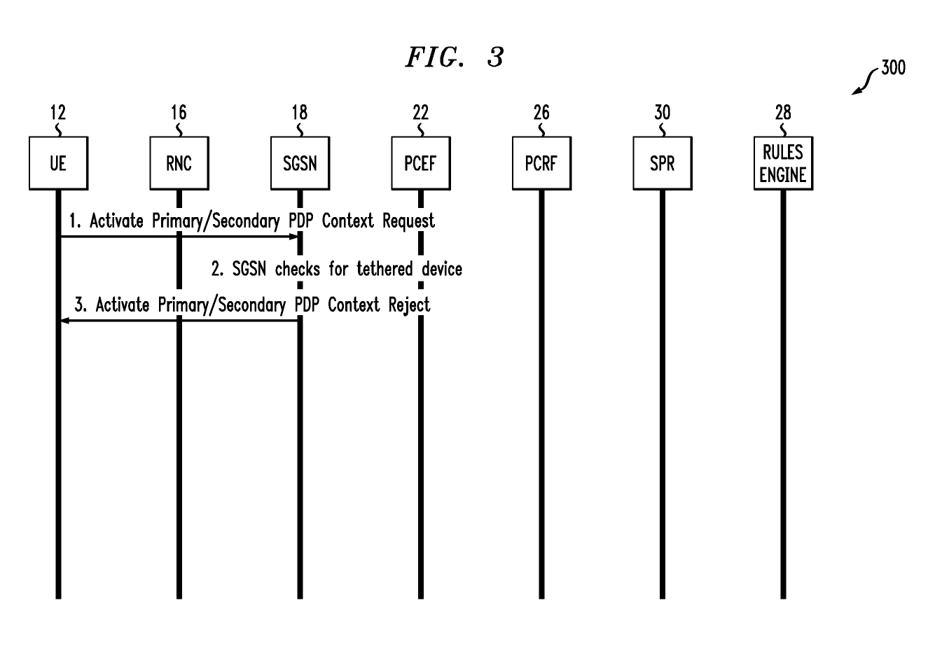

With reference to FIG. 3, if the network determines that the subscriber is not allowed to use a tethered device, the SGSN 18 sends an Activate PDP Context Reject message to the UE 12. The illustrated call flow 300 demonstrates this case. In this regard, the UE 12 attempts to activate a Packet Data Protocol (PDP) context to be able to send/receive data. However, the UE has a tethered device attached to it, and the SGSN 18 concludes that it will reject the request for a PDP context activation request as a result.

At line 1, UE 12 requests the establishment of a bearer by sending a request message such as an Activate PDP Context Request or Activate Secondary PDP Context Request to the serving SGSN. It will be appreciated by those skilled in the art that the requested bearer could be a Primary PDP context or a Secondary PDP context as defined in 3GPP standards.

In either of these messages sent by the UE 12, the UE 12 provides a new tethering indication (also referred to as a tethered device indicator) to the SGSN 18. For the purposes of this call flow, the assumption is that there is a tethered device connected to the UE and, therefore, the UE tethering indication or flag is set to YES.

In line 2, the SGSN 18 checks the new tethering indication provided by the UE, and determines that a tethered device is connected to the UE 12. As noted above, the SGSN could do either of the following:

a) Check data configured local to the SGSN 18 to determine treatment. For example, the operator may configure data local to the SGSN 18 that causes the SGSN 18 to reject all requests for PDP contexts that use tethered devices. This type of check is on a network or provider basis, as opposed to a subscriber basis.

b) Check for data provisioned in the subscriber profile. The SGSN 18 previously downloaded the subscriber profile from the HLR 20 to the SGSN 18. This data could include new tethering related fields. For example, the operator could configure that the subscriber is not allowed to have a tethered device. In one form, it would be advantageous to have per-subscriber control in this manner to support differentiated charging, in the event a rejection is not concluded.

As a further extension to both of these cases a and b above, the operator that the UE 12 belongs to could be included as an input to the decision made by the SGSN 18. For example, if the SGSN 18 belongs to operator X, and the UE 12 belongs to operator Y, the SGSN 18 could have data specific to the treatment of subscribers for operator X versus operator Y (e.g., allow tethered devices for operator X, but not operator Y).

In line 3, assuming that the SGSN 18 has concluded that the user is not allowed to establish a PDP context with a tethered device (using either case a or b above), the SGSN 18 rejects the request by sending a reject message such as a PDP Context Activation Reject or Secondary PDP Context Activation Reject message to the UE 12 (depending on the message sent by the UE in line 1).

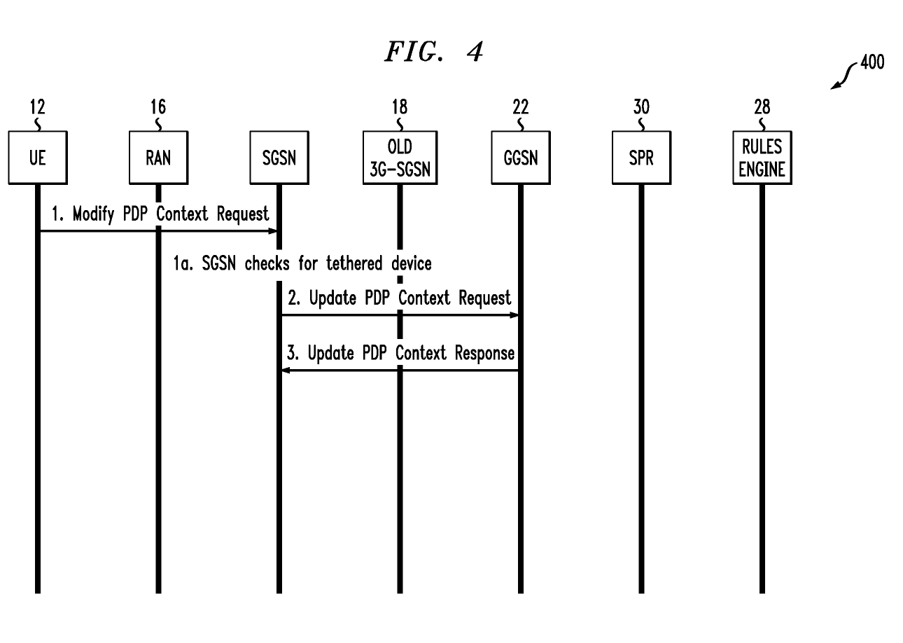

With reference to FIG. 4, call flow 400 demonstrates the case where a user device such as the UE 12 initiates modification to the data session using, for example, a PDP Context Modification procedure. Such a procedure could be invoked for one of two reasons:

a) The UE 12 is requesting a change to the PDP context such as a requested change in quality of service.

b) The UE 12 is indicating that a tethered device has been connected. The UE 12 provides this indication according to the presently described embodiments to the network because the user could connect a device at any time that a PDP context is active.

At line 1, UE 12 requests a modification to the PDP context by sending a request message such as a Modify PDP Context Request. The assumption here is that the end user attached a tethered device to the UE 12 which was the stimulus for the UE 12 to send the message. In the message, the UE 12 provides a new tethering indication (also referred to as a tethered device indicator), and for the purpose of this call flow 400, it is set to YES.

At line 1a, the SGSN 18 examines the tethering indication provided by the UE, using logic similar to that provided at line 2 of call flow 300 above.

If the SGSN 18 concludes that it will deny service, the SGSN 18 will return a Modify PDP Context Reject message to the UE at this point (similar to that shown at line 3 of call flow 300 above, except the message name is different).

For the purposes of the remainder of call flow 400, the assumption is that the new SGSN (not shown in FIG. 1) will not deny service at this point.

At line 2, the new SGSN sends an Update PDP Context Request to the GGSN 22, containing the new tethering indication (also referred to as a tethered device indicator).

At this point the messages exchanged between the GGSN (PCEF) 22, SPR 30 and Rules Engine 28 are substantially the same as that provided in FIG. 2.

At line 3, GGSN 22 returns an Update PDP Context Response message to the SGSN.

It should be appreciated that in a case of de-tethering (e.g. disconnecting the tethered device), these techniques may be used and adapted to the case where the tethering indicator indicates that no device is connected. For example, the system may change the Quality of Service or rate plan based on the de-tethered state of the user device.

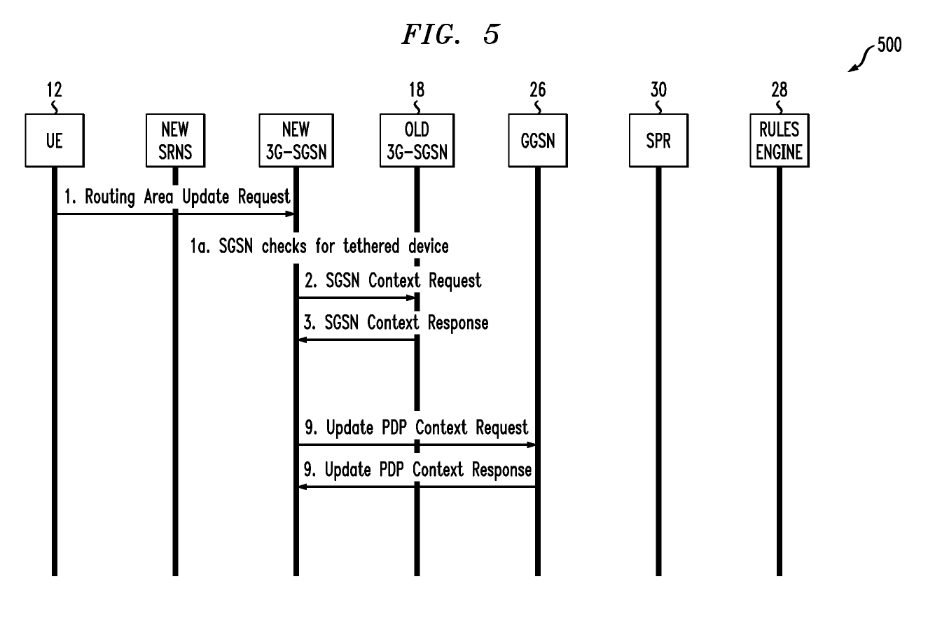

With reference to FIG. 5, call flow 500 demonstrates the case where a user device such as the UE 12 initiates a routing area change such as a Routing Area Update procedure. For ease of reference, only selected steps are shown in FIG. 5 that relate to the routing area update procedure implementing the presently described embodiments, as will be understood by those of skill in the art. Other steps that may be a part of the routing area update procedure are not shown. Effectively, the UE 12 is moving from one serving SGSN 18 to another serving SGSN. The GGSN 22 always remains the same.

At line 1, UE 12 requests service at a new SGSN by sending a request message such as a Routing Area Update Request. In the Routing Area Update Request message, the UE 12 provides a new tethering indication to the new 3G-SGSN.

At line 1a, the new 3G-SGSN examines the tethering indication (also referred to as a tethered device indicator) provided by the UE 12, using logic similar to that provided at line 2 of call flow 300 above.

If UE 12 indicates that there is a tethered device, and as a result the new SGSN concludes that it will deny service, the new SGSN will return a Routing Area Update Reject message to the UE at this point (similar to that shown in line 3 of call flow 300 above, except the message name is different).

For the purposes of the remainder of call flow 500, the assumption is that the new 3G-SGSN will not deny service at this point.

At line 2, the new 3G-SGSN sends an SGSN Context Request message to the old 3G-SGSN to retrieve context data from the old SGSN.

At line 3, the old 3G-SGSN replies with an SGSN Context Response message containing the requested context data. Given that the old 3G-SGSN had local data related to the tethering indication for the UE 12, the old 3G-SGSN could include the tethering indication in the SGSN Context Response. The method of transferring the tethering indication this way is part of the presently described embodiments, as well as the method of the UE 12 presenting it to the new 3G-SGSN as specified at line 1 above.

At this point, if the old 3G-SGSN transferred the tethering indication to the new 3G-SGSN in the previous step, the new 3G-SGSN would need to examine the tethering indicating to determine whether to deny service or not. The logic to be used would be that provided at line 1a above. Again, the assumption from this point forward is that the new 3G-SGSN does not deny service as a result of the tethering indication.

At line 9, the new 3G-SGSN sends an Update PDP Context Request to the GGSN 22, containing the new tethering indication.

At this point the messages exchanged between the GGSN (PCEF) 22, SPR 30 and Rules Engine 28 are the same as that provided in FIG. 2.

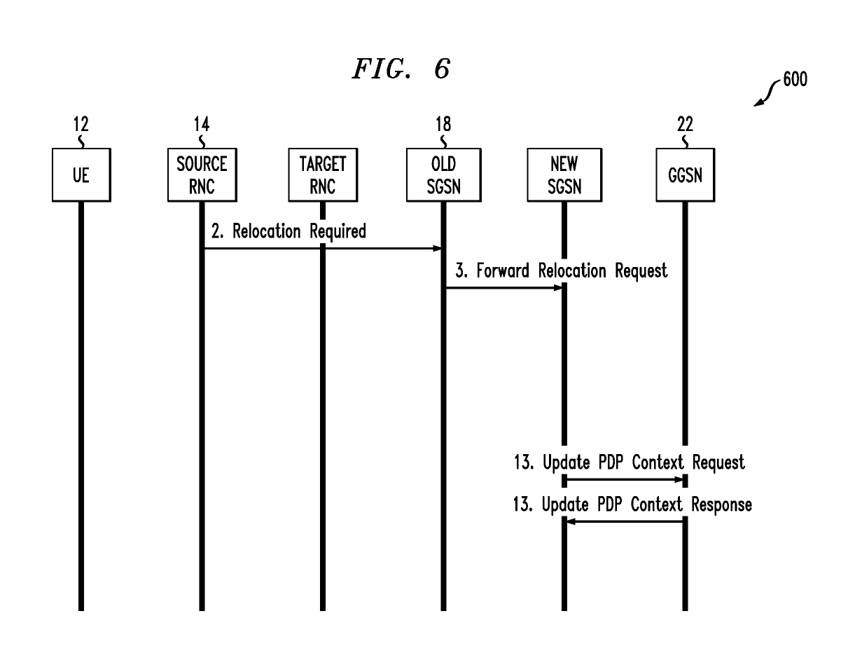

With reference to FIG. 6, this call flow demonstrates the case where the UE 12 is relocated from one serving SRNS (Serving Radio Network Subsystem) to another. The assumption here is that the old SRNS and new SRNS are served by different SGSNs. In addition, for ease of reference, only selected steps are shown in FIG. 6 that relate to the relocation procedure implementing the presently described embodiments, as will be appreciated by those of skill in the art. Other steps that may be a part of the relocation procedure are not shown.

The old SRNS is initiating the relocation of the UE. Effectively, the network is forcibly moving the UE.

At line 2, the current serving RNC (source RNC) initiates a relocation procedure by sending a Relocation Required message to the old SGSN.

At line 3, the old SGSN sends a request message such as a Forward Relocation Request to the new SGSN, requesting the relocation of the UE. According to the presently described embodiments, the old SGSN would include in the Forward Relocation Request tethering information that it has stored for the UE 12.

Upon receipt of the Forward Relocation Request, the new SGSN would examine the new tethering indication (also referred to as a tethered device indicator) and determine whether to allow or deny service based on locally provisioned data. If the tethering indication is set to YES, the new SGSN could allow the relocation to proceed but not allow PDP contexts to be relocated. That is, the user would still be attached to the network via the new SGSN but the PDP contexts would not be available to the user following the relocation. Or, it could totally reject the relocation request by returning a Forward Relocation Response to the old SGSN with an error indication.

The remainder of this call flow assumes the new SGSN allows the relocation procedure to proceed. At line 13, the new SGSN sends an Update PDP Context Request to the GGSN, containing the new tethering indication. At this point the messages exchanged between the GGSN (PCEF), SPR and Rules Engine are the same as that provided in FIG. 2. The GGSN returns the Update PDP Context Response to the new SGSN.

It should be appreciated that the call flow of FIG. 6 may also include a routing area update procedure, such as that shown in FIG. 5, following the relocation procedure. In this way, the tethered device indicator could be passed through the system by one or both of the user device or a network element such as the old SGSN.

Similarly, in the context of a routing area update of FIG. 5, the tethered device indicator may be passed through the system by one or both of the user device or a network element such as an SGSN.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for handling data sessions performed by tethered user devices in a network, the method comprising:
receiving a tethered device indicator by a network element, the tethered device indicator originating from a request message from a user device;
detecting the indicator by the network element; and,
based on the indicator, performing one of rejecting a data session requested by the user device or managing the data session requested by the user device.

2. The method as set forth in claim 1 wherein the tethered device indicator is a flag set in an information element of the request message.

3. The method as set forth in claim 1 wherein the request message is data session request message.

4. The method as set forth in claim 3 wherein the data session request message is a PDP Context Request message.

5. The method as set forth in claim 1 wherein the request message is a request to modify a data session.

6. The method as set forth in claim 5 wherein the request to modify a data session is a Modify PDP Context Request message.

7. The method as set forth in claim 1 wherein the request message is a routing area update request.

8. The method as set forth in claim 1 further comprising sending the indicator by the network element to a second network element based on a relocation request.

9. The method as set forth in claim 1 further comprising sending a reject message to the user device if rejecting is performed by the network element.

10. The method as set forth in claim 1 wherein managing the data session includes at least one of setting a quality of service and establishing a rate plan.

11. A system for handling data sessions performed by tethered user devices in a network, the system comprising:
means for receiving a tethered device indicator by a network element, the tethered device indicator originating from a request message from a user device;
means for detecting the indicator by the network element;
based on the indicator, means for performing one of rejecting a data session requested by the user device or managing the data session requested by the user device.

12. The system as set forth in claim 11 wherein the tethered device indicator is a flag set in an information element of the request message.

13. The system as set forth in claim 11 wherein the request message is data session request message.

14. The system as set forth in claim 13 wherein the data session request message is a PDP Context Request message.

15. The system as set forth in claim 11 wherein the request message is a request to modify a data session.

16. The system as set forth in claim 15 wherein the request to modify a data session is a Modify PDP Context Request message.

17. The system as set forth in claim 11 wherein the request message is a routing area update request.

18. The system as set forth in claim 11 further comprising means for sending the indicator by the network element to a second network element based on a relocation request.

19. The system as set forth in claim 11 further comprising means for sending a reject message to the user device if rejecting is performed by the network element.

20. The system as set forth in claim 11 wherein means for managing the data session includes at least one of setting a quality of service and establishing a rate plan.
